(19) United States
(12) Patent Application Publication
(10) Pub. No.: US 2016/0208875 A1
(43) Pub. Date: Jul. 21, 2016

(54) SPRING AND METHOD FOR MANUFACTURING THE SPRING

(71) Applicant: CHUO HATSUJO KABUSHIKI KAISHA, Aichi (JP)

(72) Inventor: Hidetoshi Yoshikawa, Nagoya (JP)

(73) Assignee: CHUO HATSUJO KABUSHIKI KAISHA, Nagoya (US)

(21) Appl. No.: 15/023,458

(22) PCT Filed: Sep. 2, 2014
(86) PCT No.: PCT/JP2014/073059

§ 371 Date: Mar. 21, 2016

(30) Foreign Application Priority Data
Oct. 28, 2013 (JP) 2013-223529

(51) Int. Cl. F16F 1/02; C21D 1/06; C21D 9/02; C23C 8/26; C23F 17/00; C22C 38/34; C22C 38/24; C22C 38/22; C22C 38/04; B24C 1/10; C21D 7/06

(52) U.S. Cl. CPC F16F 1/021; B24C 1/10; F16F 1/024; C21D 1/06; C21D 9/02; C23C 8/26; C21D 7/06; C22C 38/34; C22C 38/24; C22C 38/22; C22C 38/04; C23F 17/00

(57) ABSTRACT

A spring, fatigue strength thereof is improved is provided. A spring 10 includes a steel layer 12 and a compound layer 14 provided on a surface of the steel layer and containing nitride. The compound layer 14 contains an ε phase, and a compressive residual stress of the ε phase is set to range from 800 to 1400 MPa.

### TECHNICAL FIELD

The technique disclosed in the present description relates to a spring. More specifically, the present description relates to a technique for improving fatigue strength of springs (for example, valve springs, springs for clutches, and the like).

### BACKGROUND ART

A technique for generating a compressive residual stress in a surface of a material by shot peening in order to improve fatigue strength of springs, has been known (for example, Japanese Patent Application Publication No. H10-118930). In this technique, a plurality of times of shot peening is performed by changing a particle diameter and a material of shot media. Thus, it is considered that fatigue strength. may be improved also for a spring having a high hardness.

### SUMMARY

### Technical Problem

An object of the present description is to provide a spring having improved fatigue strength.

### Solution to Technical Problem

A spring disclosed herein comprises a steel layer and a compound layer provided on a surface of the steel layer and containing nitride. The compound layer contains an ε phase, and a compressive residual stress of the ε phase is set to range from 800 to 1400 MPa.

In the spring, the nitride compound layer is formed on the surface of the steel layer, and the compressive residual stress of the ε phase contained in the compound layer is set to range from 800 to 1400 MPa. As described below, the inventor of the present application has found, as a result of extensive studies, that, in a spring having a compound layer (nitride) formed on a surface of a steel layer, a compressive residual stress generated in an ε phase contained in the compound layer allows fatigue strength of the spring to be remarkably improved. In the spring, the ε phase contained in the compound layer is adjusted so as to have the stress ranging from 800 to 1400 MPa, whereby the spring excellent in fatigue strength can be obtained.

Moreover, the present description provides a new method for manufacturing the spring described above. The method comprises removing a surface scratch on a surface of a spring wire, nitriding the spring wire, the surface scratch of which has been removed, and performing a shot peening on the surface of the spring wire after the nitriding of the spring wire. A plurality of times of shot peening steps is conducted in the performing of the shot peening, and a hardness of shot media used in a final shot peening step is set to range from 1100 to 1300 HV.

in the manufacturing method, surface scratches on the surface of the spring wire are removed before the surface of the spring wire is hardened by nitriding. Therefore, the surface scratches can be removed with surface roughness of the spring wire being suppressed. Further, the shot media used for the shot peening has a high hardness (1100 to 1300 HV), whereby a high compressive residual stress can be generated in the spring wire having been subjected to nitriding. As a result, the spring excellent in fatigue strength can be manufactured.

### BRIEF DESCRIPTION OF DRAWINGS

FIG. 1 is a cross-sectional view of a spring according to an embodiment;

FIG. 2 is a flow chart showing a process of manufacturing the spring according to the embodiment;

FIG. 3 is a graph showing a compressive residual stress (relationship between compressive residual stress in an ε phase and that in an α phase) generated in a surface of the spring according to the embodiment;

FIG. 4 is a graph showing results (relationship between a fatigue strength and the compressive residual stress of the ε phase) of measuring the fatigue strength of the spring according to the embodiment; and

FIG. 5 is a graph showing results (relationship between a full width at half maximum of the e phase and the fatigue strength) of measuring the fatigue strength of the spring according to the embodiment.

### DESCRIPTION OF EMBODIMENTS

In a spring disclosed in the present description, a full width at half maximum of an ε phase may be less than 4.0. Increase of the full width at half maximum of the ε phase leads to increase of a compressive residual stress of the ε phase, whereby fatigue strength of the spring can be improved. However, as indicated below in measurement results, when the full width at half maximum of the ε phase is greater than or equal to 4.0, fatigue strength of the spring is reduced on the contrary. Therefore, the full width at half maximum of the ε phase is set to be less than 4.0, whereby the compressive residual stress of the e phase can be prevented from being excessively generated, whereby reduction of fatigue strength of the spring can be inhibited.

In the spring disclosed in the present description, the compressive residual stress of the ε phase may be set to range from 1100 to 1300 MPa. In this configuration, the fatigue strength can be further improved.

In a spring disclosed in the present description, the steel layer may contain, in percent by mass, C: 0.60 to 0.80%, Si: 1.30 to 2.50%, Mn: 0.30 to 1.00%, Cr: 0.40 to 1.40% and may contain at least one of Mo: 0.05 to 0.25%, V: 0.05 to 0.60%, W: 0.08 to 0.20%, and a rest of the steel layer may contain iron and inevitable impurities. In this configuration, the steel for forming the spring can be formed of an appropriate material, thereby further improving fatigue strength.

### Embodiment

A spring 10 according to an embodiment will be described. The spring 10 is used as a valve spring for automobile engines. The spring 10 is configured of a spring wire that has been formed into a coil shape, and the spring wire is wound so as to be adjacent at predetermined intervals.

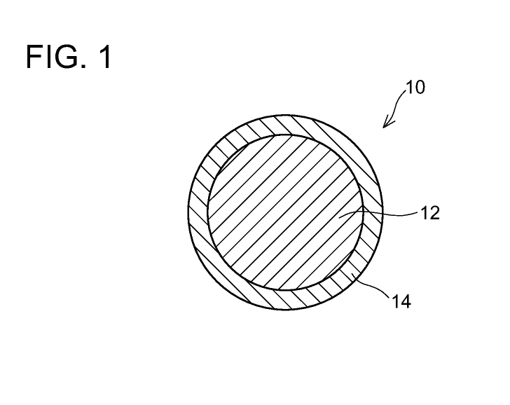

As shown in FIG. 1, the spring 10 comprises a steel layer 12 and a compound layer 14. The steel layer 12 is formed by, for example, the spring wire being thermally treated. The steel layer 12 (that is, the spring wire) may contain, for example, C (carbon), Si (silicon), Mn (manganese), Cr (chromium), W (tungsten), iron, and inevitable impurities. in this case, the respective elements may be contained, in percent by mass, in ranges of C: 0.60 to 0.80%, Si: 1.30 to 2.50%, Mn: 0.30 to 1.00%, Cr: 0.40 to 1.40%, W: 0.08 to 0.20%, and the remainder may contain Fe (iron) and inevitable impurities. The percentage of C is greater than or equal to 0.60% because, if the percentage of C is less than 0.60%, it is difficult to satisfy both durability and sag resistance. Further, the percentage of C is not greater than 0.80% because, if the percentage of C is greater than 0.80%, formability is reduced, and crack, breakage, or the like is likely to be generated in processing. The percentage of Si is greater than or equal to 1.30% because, if the percentage of Si is less than 1.30%, sag resistance may not become sufficient. The percentage of Si is not greater than 2.50% because, if the percentage of Si is greater than 2.50%, an amount of decarburization in thermal treatment exceeds an allowable range, and durability is adversely affected. The percentage of Mn is greater than or equal to 0.30% because, if the percentage of Mn is less than 0.30%, strength may not become sufficient. Further, the percentage of Mn is not greater than 1.00% because, if the percentage of Mn is greater than 1.00%, an amount of retained austenite is excessively great. The percentage of Cr is greater than or equal to 0.40% because, if the percentage of Cr is less than 0.40%, solid solution strength and hardenability may not become sufficient. Further, the percentage of Cr is not greater than 1.40% because, if the percentage of Cr is greater than 1.40%, an amount of retained austenite is excessively great. The percentage of W is greater than or equal to 0.08% because, if the percentage of W is less than 0.08%, an effect of adding W (improvement of hardenability, enhancement of strength, or the like) cannot be obtained. Further, the percentage of W is not greater than 0.20% because, if the percentage of W is greater than 0.20%, coarse carbide is generated to deteriorate mechanical characteristics such as ductility.

The steel layer 12 may contain Mo (molybdenum) and/or V (vanadium) together with or instead of W. When Mo is contained, strength of the steel can be improved, and hardenability can be improved. Further, when V is contained, a size of a carbide precipitated in the steel layer 12 can be made fine, to further improve the strength of the steel layer 12. In a case where the steel layer 12 contains Mo and/or V, the elements are preferably contained, in percent by mass, in ranges of Mo: 0.05 to 0.25% and V: 0.05 to 0.60%. The percentage of Mo is greater than or equal to 0.05% because, if the percentage of Mo is less than 0.05%, strength may not become sufficient. Further, the percentage of Mo is not greater than 0.25% because, if the percentage of Mo is greater than 0.25%, stabilization effect of retained austenite cannot be ignored. Further, the percentage of V is greater than or equal to 0.05% because, if the percentage of V is less than 0.05%, a sufficient amount of carbide is not generated, and thus an effect of preventing crystal grain growth cannot be obtained. Further, the percentage of V is not greater than 0.60% because, if the percentage of V is greater than 0.60%, a vanadium carbide itself grows to become large, thereby adversely affacting durability.

The compound layer 14 is formed over an entirety of a surface of the steel layer 12. A thickness of the compound layer 14 is less than or equal to 7 μm. Since the thickness of the compound layer 14 is less than or equal to 7 μm, reduction of strength due to the fragile compound layer can be prevented. The compound layer 14 contains N (nitrogen) in addition to C, Si, Mn, Cr, W, Fe and inevitable impurities which are contained in the steel layer 12, and the compound layer 14 contains a compound (nitride) of N and a metallic element such as Si, Mn, Cr, W, or Fe and the like. The concentration of N in the compound layer 14 is not limited to any specific one, and N may be contained in a range of 5.0 to 6.1% by mass, for example.

On an outermost surface of the compound layer 14, an ε phase (Fe₄N based) having a hexagonal close-packed (hcp) structure is formed, and C, Si, Mn, Cr, W, and the like are solid-dissolved in the ε phase. The ε phase in the compound layer 14 is hard and fragile. In the present embodiment, a compressive residual stress is generated in the ε phase, thereby improving durability of the spring 10. That is, a compressive residual stress of 800 to 1400 MPa is preferably generated in the ε phase of the compound layer 14. The compressive residual stress of the ε phase is more preferably 1100 to 1300 MPa. As indicated below in the experiment results, this is because, when the compressive residual stress is less than 800 MPa, fatigue strength cannot be sufficiently improved, and when the compressive residual stress is greater than 1400 MPa, fatigue strength is reduced.

Further, the full width at half maximum (which is an index for evaluation as to Whether or not the compressive residual stress (strain) is introduced, and is calculated from a profile of an X-ray intensity obtained by an X-ray residual stress measurement) of the ε phase is preferably less than 4.0. That is, increase of the full width at half maximum of the ε phase also leads to increase of the compressive residual stress of the ε phase, whereby fatigue strength of the spring can be improved. However, as indicated below in the experiment results, when the full width at half maximum of the ε phase is greater than or equal to 4.0, fatigue strength of the spring is reduced on the contrary. Therefore, when the full width at half maximum of the ε phase is less than 4.0, excessive generation of the compressive residual stress of the ε phase can be prevented, to thereby inhibit reduction of fatigue strength of the spring.

A surface roughness of the compound layer 14 (that is, the surface roughness of the spring 10) is preferably set such that the arithmetic average roughness (Ra) is less than or equal to 0.9 μm. When the surface roughness Ra of the compound layer 14 is less than or equal to 0.9 μm, surface scratches that may cause concentration of stress is removed from the surface of the compound layer 14. Thus, fatigue strength of the spring can be improved.

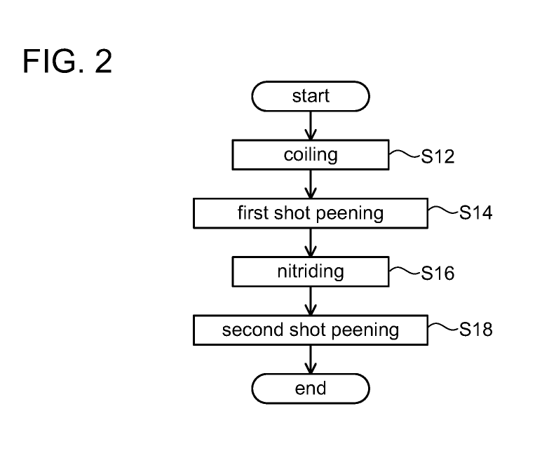

Next, a method for manufacturing the spring 10 will be described with reference to FIG. 2. As shown in FIG. 2, the spring wire is firstly formed into a coil shape by a coiling machine (S12). The spring wire contains, in percent by mass, C: 0.60 to 0.80, Si: 1.30 to 2.50, Mn: 0.30 to 1.00, Cr: 0.40 to 1.40, W: 0.08 to 0.20, and the remainder may contain iron and inevitable impurities. The spring wire may further contain, in percent by mass. Mo: 0.05 to 0.25, and/or V: 0.05 to 0.60.

After the spring wire has been formed into a coil shape, an end of the spring wire is cut, and the spring wire having been formed into a coil shape is then subjected to low-temperature annealing, and an end surface of the spring wire having been formed into a coil shape is ground. Thus, the spring wire is formed into a spring shape.

Next, a first shot peening (pre-shot-peening) is performed on the surface of the spring wire having been formed into a spring shape (S14). The first shot peening is performed not for generating a compressive residual stress in the spring wire but for removing surface scratches on the surface of the spring wire. Therefore, shot media having a low hardness is used, and surface roughness of the spring wire is also supressed. As a result, the surface roughness of the spring wire on which the first shot peening has been performed is such that, for example, the arithmetic average roughness (Ra) is 1.18 μm. In the first shot peening, shot media having, for example, a diameter of φ0.3 mm and a hardness of 390 to 510 HV may be used. Further, the shot speed of the shot media may be preferably 60 to 90 m/s.

Next, the spring wire, the surface scratches of which have been removed, is subjected to nitriding under an ammonia atmosphere (S16). Thus, the compound layer 14 containing a nitride is formed on the surface of the spring wire, and the steel layer 12 containing no nitride is formed in a center portion of the spring wire. The nitriding can be performed in such a condition that the temperature is higher than or equal to 450° C., and not higher than 540° C. (for example, 500° C.), and a treatment time is one to four hours (for example, 1.5 hours). When the treatment time is less than two hours, the thickness of the compound layer 14 can be appropriately adjusted (for example, 5 μm).

Next, a second shot peening is performed on the surface of the spring wire in order to improve fatigue resistance of the spring wire (S16). The second shot peening can be performed in a plurality of steps. The plurality of times of shot peening is performed, whereby the compressive residual stress can be generated deep into the spring wire. In the second shot peening, for example, a first shot peening step (for example, the diameter of shot media is φ0.6 mm, and the hardness of the shot media is 650 to 750 HV) may be performed on the surface of the spring wire having been just subjected to the nitriding, a second shot peening step (for example, the diameter of shot media is φ0.3 mm, and the hardness of the shot media is 650 to 750 HV) may be then performed, and a third shot peening step (for example, the diameter of shot media is φ0.1 mm, and the hardness of the shot media is 1180 to 1230 HV) may be further performed. By performing the shot peening in multiple steps with changing the diameter and the hardness of the shot media, a compressive residual stress can be effectively generated in the spring wire. In the above-described example, the shot media having the hardness that is higher than or equal to 1100 HV, and the particle diameter of φ0.1 mm, is used for the third shot peening step, whereby a high compressive residual stress can be generated deep into the surface (that is, the compound layer 14 having a high hardness) of the spring material having been subjected to the nitriding. Further, in each of the first shot peening step, the second shot peening step, and the third shot peening step, the shot speed of the shot media is preferably 60 to 90 m/s.

After the second shot peening has been performed in S16, the spring wire is subjected to low-temperature annealing, and setting is then performed on the spring wire. Thus, the spring 10 is manufactured from the spring wire.

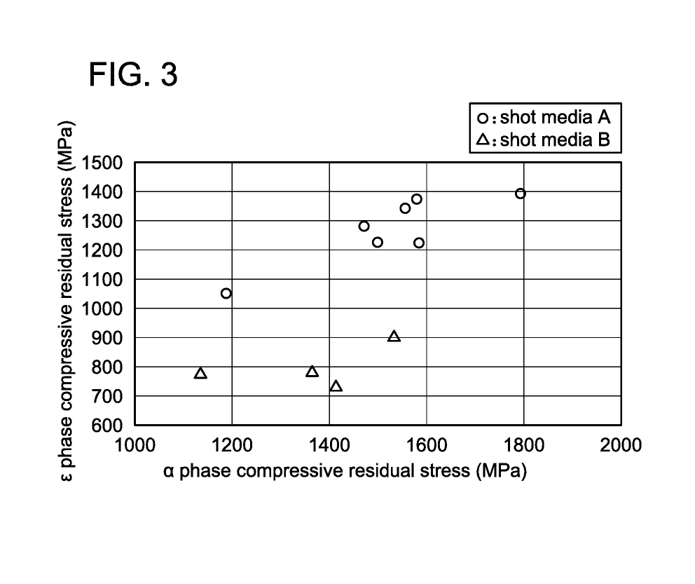

Next, a compressive residual. stress and a fatigue strength were measured for a spring that was actually manufactured from a spring wire (C: 0.73, Si: 2.16, Mn: 0.71, Cr: 1.00, W: 0.15, Mo: 0.13, V: 0.10, in percent by mass, and the remainder contains iron and inevitable impurities) (hereinafter, referred to as experiment example). The results of the measurement will be described. In the measurements, the first shot peening, the nitriding, and the second shot peening (three step shot peening) were performed on the spring wire having been coiled, and a compressive residual stress and a fatigue strength were measured after these treatments. In the experiment example, in the third shot peening step of the second shot peening, shot media A (the diameter of the shot media was φ0.1 mm, and the hardness of the shot media was 1180 to 1230 HV) was used. Meanwhile, in comparative example, in the third shot peening step of the second shot peening, shot media B (the diameter of the shot media was φ0.1 mm, and the hardness of the shot media was 700 to 830 HV) was used. Hereinafter, in FIGS. 3 to 5, the measurement results of experiment examples are represented as the shot media A, and the measurement results of comparative examples are represented as the shot media B. The other conditions were the same between experiment example and comparative example. That is, the first shot peening was performed by using shot media having the diameter of φ0.3 mm and the hardness of 390 to 510 HV. The nitriding was performed at a temperature of 500° C. for 1.5 hours. In the second shot peening, the first shot peening step (the diameter of the shot media was φ0.6 mm and the hardness of the shot media was 650 to 750 HV), the second shot peening step (the diameter of the shot media was φ0.3 mm, and the hardness of the shot media was 650 to 750 HV), and the third shot peening step (the shot media A or B) were performed.

FIG. 3 shows results of measurements of the compressive residual stress of the spring (represented as the shot media A) of experiment examples, and the compressive residual stress of the spring (represented as the shot media B) of comparative examples. As a measurement method, an X-ray residual stress measurement (sin²φ method) was used. As is apparent from FIG. 3, the compressive residual stress generated in the ε phase of the spring of experiment examples is higher than the compressive residual stress generated in the ε phase of the spring of comparative examples. Meanwhile, there was not a great difference between the compressive residual stress generated in the α phase of the spring of experiment examples and the compressive residual stress generated in the α phase of the spring of comparative examples. From the measurement results, it was confirmed that a high residual stress could be generated in the s phase by using shot media having a high hardness in the third shot peening step.

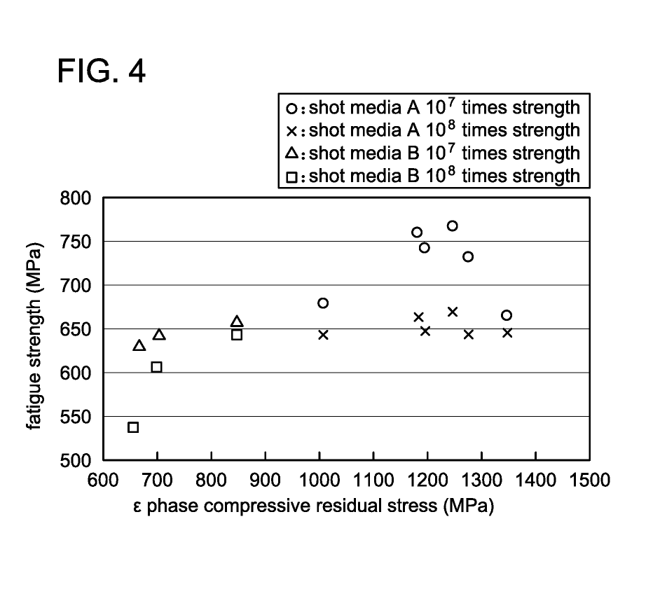

FIG. 4 shows results of measurements of a fatigue testing that was conducted for the spring (represented as the shot media A) of experiment examples, and the spring (represented as the shot media B) of comparative examples. In the fatigue testing, fatigue strength in a case of 10⁷ times of repeated stress and fatigue strength in a case of 10⁸ times of repeated stress were measured. As is apparent from FIG. 4, both the fatigue strength in the case of 10⁷ times of repeated stress and the fatigue strength in the case of 10⁸ times of repeated stress are higher in the spring of experiment examples than in the spring of comparative examples. In particular, the fatigue strength of the spring of experiment examples indicates a high value of about 650 MPa in the case of 10⁸ times of repeated stress, and the variation thereof is small. That is, a high fatigue strength can be stably obtained. Further, a relationship between a fatigue strength and a compressive residual stress generated in the ε phase is such that as the compressive residual stress generated in the ε phase becomes high the fatigue strength also becomes high. In particular, when the compressive residual stress generated in the ε phase is higher than 800 MPa, the fatigue strength in the case of 10⁷ times of repeated stress is higher than or equal to 650 MPa, and the fatigue strength in the case of 10⁸ times of repeated stress also indicates a high value of about 650 MPa. However, when the compressive residual stress generated in the ε phase is higher than 1300 MPa, the fatigue strength (in particular, in the case of 10⁷ times of repeated stress) is reduced. When the compressive residual stress generated in the ε phase ranges from 1100 to 1300 MPa, the fatigue strength in the case of 10⁷ times of repeated stress indicates a very high value.

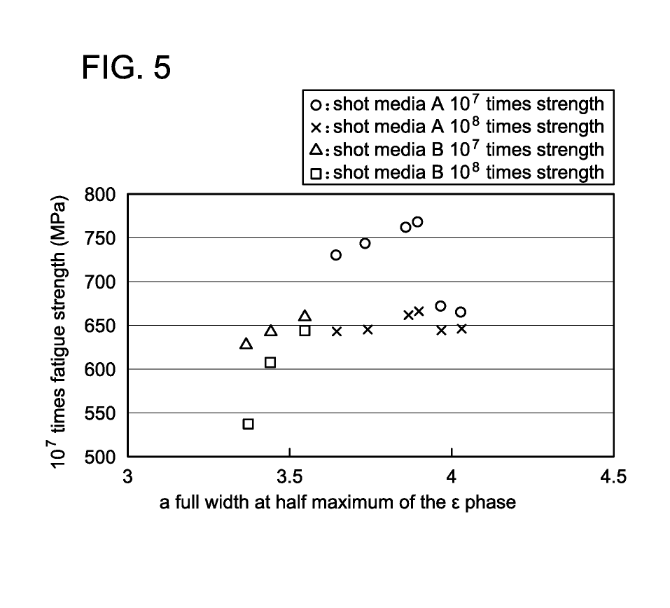

FIG. 5 shows a relationship between a full width at half maximum obtained when the compressive residual stress is measured (specifically, a full width at half maximum of an X-ray intensity obtained by the X-ray residual stress measurement) and a fatigue strength for each of the spring (represented as the shot media A) of experiment examples and the spring (represented as the shot media B) of comparative examples. As is apparent from FIG. 5, the great full width at half maximum brings forth the fatigue strength of the spring. However, when the full width at half maximum is greater than or equal to 4.0, the fatigue strength of the spring is reduced on the contrary.

As is apparent from the above-described results, in the spring of experiment examples, a high compressive residual stress is generated in the s phase and the fatigue strength is improved. In particular, when the compressive residual stress generated in the ε phase is 800 to 1400 MPa (more preferably, 1100 to 1300 MPa), fatigue strength can be remarkably improved.

While embodiments of the present invention have been described above in detail, these embodiments are merely illustrative and place no limitation on the scope of the patent claims. The technology described in the patent claims also encompasses various changes and modifications to the specific examples described above.

For example, although the above-described embodiment is applied to a valve spring for automobile engines, the present description is not limited to this embodiment, and are applicable to other springs (for example, springs for clutches). Further, the spring wire may contain inevitable impurities such as P (phosphorus) or S (sulfur). The inevitable impurities may cause reduction of the strength of the spring. Therefore, the lower concentration thereof is more preferable. For example, in percent by mass, the percentage of P contained in the spring wire is preferably less than or equal to 0.025%, and the percentage of S contained in the spring wire is preferably less than or equal to 0.025%. Further, the number of steps of the shot peening in the second shot peening performed on the surface of the spring wire can be determined as appropriate according to durability required for the spring wire. For example, in order to generate a sufficient compressive residual stress in the spring wire, the shot peening is preferably performed in at least two steps, and is more preferably performed in three steps.

The technical elements explained in the present description or drawings provide technical utility either independently or through various combinations. The present invention is not limited to the combinations described at the time the claims are filed, Further, the purpose of the examples illustrated by the present description or drawings is to satisfy multiple objectives simultaneously, and satisfying any one of those objectives gives technical utility to the present invention.

1. A spring comprising:
a steel layer; and
a compound layer provided on a surface of the steel layer and containing nitride,
wherein the compound layer contains an ε phase, and
a compressive residual stress of the ε phase is set to range from 800 to 1400 MPa.

2. The spring according to claim 1, wherein
a full width at half maximum of the ε phase is set to be smaller than 4.0.

3. The spring according to claim 1, wherein
the compressive residual stress of the ε phase is set to range from 1100 to 1300 MPa.

4. The spring according to claim 3, wherein
the steel layer contains, in percent by mass, C: 0.60 to 0.80%, Si: 1.30 to 2.50%, Mn: 0.30 to 1.00%, Cr: 0.40 to 1.40% and contains at least one of Mo: 0.05 to 0.25%, V: 0.05 to 0.60%, W: 0.08 to 0.20%, and
a rest of the steel layer contains iron and inevitable impurities.

5. A method for manufacturing a spring comprising:
removing a surface scratch on a surface of a spring wire,
nitriding the spring wire, the surface scratch of which has been removed; and
performing a shot peening on the surface of the spring wire after the nitriding of the spring wire,
wherein a plurality of times of shot peening steps is conducted in the shot peening, and
a hardness of shot media used in a final shot peening step is set to range from 1100 to 1300 HV.

6. The spring according to claim 1, wherein
the compressive residual stress of the ε phase is set to range from 1100 to 1300 MPa.

7. The spring according to claim 1, wherein
the steel layer contains, in percent by mass, C: 0.60 to 0.80%, Si: 1.30 to 2.50%, Mn: 0.30 to 1.00%, Cr: 0.40 to 1.40% and contains at least one of Mo: 0.05 to 0.25%, V: 0.05 to 0.60%, W: 0.08 to 0.20%, and
a rest of the steel layer contains iron and inevitable impurities.

8. The spring according to claim 2, wherein
the steel layer contains, in percent by mass, C: 0.60 to 0.80%, Si: 1.30 to 2.50%, Mn: 0.30 to 1.00%, Cr: 0.40 to 1.40% and contains at least one of Mo: 0.05 to 0.25%, V: 0.05 to 0.60%, W: 0.08 to 0.20%, and
a rest of the steel layer contains iron and inevitable impurities.

9. The spring according to claim 6, wherein
the steel layer contains, in percent by mass, C: 0.60 to 0.80%, Si: 1.30 to 2.50%, Mn: 0.30 to 1.00%, Cr: 0.40 to 1.40% and contains at least one of Mo: 0.05 to 0.25%, V: 0.05 to 0.60%, W: 0.08 to 0.20%, and
a rest of the steel layer contains iron and inevitable impurities.

10. The spring according to claim 2, wherein
the full width at half maximum of the ε phase is set to range from 3.5 to 4.0.

11. The spring according to claim 6, wherein
the compressive residual stress of the ε phase is set to range from 1200 to 1300 MPa.

12. The method for manufacturing a spring according to claim 5, wherein
the performing of the shot peening includes at least one shot peening step conducted in advance of the final shot peening step, and
a hardness of shot media in the final shot peening step is higher than a hardness of shot media in the at least one shot peening step.

13. The method for manufacturing a spring according to claim 5, wherein
the performing of the shot peening includes a first shot peening step, a second shot peening step, and a third shot peening step,
a diameter of shot media in the first shot peening step is larger than a diameter of shot media in the second shot peening step,
a hardness of the shot media in the first shot peening step is equal to a hardness of the shot media in the second shot peening step,
a diameter of shot media in the third shot peening step is smaller than the diameter of the shot media in the second shot peening step, and
a hardness of the shot media in the third shot peening step is higher than the hardness of the shot media in the first and the second shot peening steps.
